(19) United States
(12) Patent Application Publication
(10) Pub. No.: US 2010/0098995 A1
(43) Pub. Date: Apr. 22, 2010

(54) Direct methanol fuel cell system and portable electronic device

(75) Inventors: Hiroshi Obuse, Tokyo (JP); Koichi Mori, Tokyo (JP); Mitsuru Nozue, Tokyo (JP); Tetsuo Motohashi, Tokyo (JP)

Correspondence Address: POSZ LAW GROUP, PLC, 12040 SOUTH LAKES DRIVE, SUITE 101, RESTON, VA, 20191, US

(73) Assignee: KURITA WATER INDUSTRIES LTD, Tokyo (JP)

(21) Appl. No.: 12/311,702

(22) PCT Filed: Oct. 9, 2007
(86) PCT No.: PCT/JP2007/069687

§ 371 Date: Nov. 12, 2009

(30) Foreign Application Priority Data
Oct. 11, 2006 (JP) 2006-278162
Oct. 11, 2006 (JP) 2006-278163
Oct. 11, 2006 (JP) 2006-278164
Oct. 11, 2006 (JP) 2006-278165

(51) Int. Cl. H01M 8/10

(52) U.S. Cl. 429/33

(57) ABSTRACT

A fuel cell comprises a fuel electrode, an electrolyte membrane and an air electrode 4. The fuel electrode and the air electrode 4 are electrically connected by way of an electric circuit L. A solid-state methanol storage container serving as a fuel container is disposed in the vicinity of the fuel cell on the side of the fuel electrode. The storage container comprises a rectangular box-like casing, the interior of which is packed with solid-state methanol. An opening serving as an air-permeable portion is formed on the lower face side of the storage container. By dividing the opening by a synthetic resin mesh, which is a permeable material, the solid-state methanol is held with secured air permeability. The resulting direct methanol fuel cell system uses extremely safe solid-state methanol in a fuel cartridge.

### TECHNICAL FIELD

The present invention relates to a direct methanol fuel cell system having solid-state methanol as a fuel, and more particularly to a direct methanol fuel cell system suitable for small portable electronic devices.

### BACKGROUND ART

Solid polymer electrolyte fuel cells are devices in which a fuel electrode (anode) and an oxidant electrode (cathode) are respectively bonded to both faces of a solid electrolyte membrane, such as a membrane of perfluorosulfonic acid or the like, as the electrolyte, and wherein power is generated through an electrochemical reaction sustained by supplying hydrogen or methanol to the anode, and oxygen to the cathode. Among such fuel cells, solid polymer electrolyte-type fuel cells having methanol as a fuel, called “direct methanol fuel cells (DMFC)”, generate power in accordance with the following reactions.

Anode: CH₃OH+H₂O→6H⁺+CO₂+6e⁻ [1]

Cathode: 3/2O₂+6H⁺+6e⁻→3H₂O [2]

To support these reactions, the electrodes are made of a mixture of a solid polymer electrolyte with carbon microparticles that carry a catalytic substance.

In such a direct methanol fuel cell, the methanol supplied to the anode passes through pores in the electrode and reaches the catalyst. The catalyst causes the methanol to decompose and generate electrons and hydrogen ions, in accordance with reaction [1] above. The hydrogen ions traverse the electrolyte of the anode and the solid electrolyte membrane interposed between the two electrodes, and reach the cathode, where they react with oxygen supplied to the cathode, and the electrons flowing through an external circuit, to generate water, in accordance with reaction [2] above. The electrons released by the methanol traverse the catalyst carrier in the anode and are led to an external circuit, through which they flow into the cathode. As a result, power can be extracted at the external circuit on account of the flow of electrons from the anode to the cathode.

Direct methanol fuel cells having methanol fuel are useful as small power sources for portable electronic devices, thanks to their low operating temperature and the fact that they require no major auxiliary equipment, among other advantages. Efforts to develop direct methanol fuel cells as next-generation power sources for laptops, cell phones and the like have intensified in recent years.

The methanol used as fuel, however, is a liquid, and hence prone to leaking. The flammability and toxicity of methanol itself are also grounds for concern. Coming up with ways of using methanol safely has thus become a challenge. Further demerits of using a liquid fuel include, for instance, impairment of fuel cell performance when impurities dissolved in the liquid fuel are supplied to the fuel cell, and the phenomenon of crossover, whereby methanol, as the liquid fuel component, permeates across the electrolyte membrane of the fuel cell and into the air electrode. In particular, occurrence of crossover not only reduces power generation efficiency per unit volume of fuel, but gives rise also to hazardous substances such as formaldehyde, formic acid and methyl formate that are generated through oxidation in the air electrode. Solving the problem of crossover has become thus a key issue for the practical viability of DMFCs.

The mainstream DMFC systems developed in recent years have come to use methanol in ever higher concentrations with a view to increasing fuel volume density. However, the problem of crossover is exacerbated by such higher fuel concentrations. Research is being conducted thus on reducing crossover by improving the materials, such as the electrolyte membrane, that are used in the cell, but the results thus far have proved insufficient. This constitutes a major obstacle for the commercialization of DMFCs.

To address the issue of methanol safety, among others, the present applicant has proposed therefore various “solid-state methanol fuels” in which methanol is made into a solid state through formation of a molecular compound, to reduce the likelihood of fuel leaking while substantially reducing the flammability of the fuel (Patent documents 1 to 3). When the solid-state methanol comes into contact with water, the methanol in the solid is released into the water. The resulting methanol aqueous solution can also be used as the fuel of a direct methanol fuel cell.

Patent document 1: JP 2006-040629 A

Patent document 2: JP 2005-325254 A

Patent document 3: International Patent Publication No. 2005/062410

### DISCLOSURE OF THE INVENTION

### Problem to be Solved by the Invention

In the usage methods proposed in Patent documents 1 to 3, however, methanol is extracted by bringing solid-state methanol into contact with water, to generate a methanol aqueous solution that is supplied to a fuel cell. The fuel cell system in this approach suffers therefore from the same problems of leakage, crossover and so forth of the methanol aqueous solution, as in the case of liquid fuels. This water-supply scheme, moreover, requires some water supply mechanisms such as a water tank, pump or the like. A simpler device structure requiring no such water supply means is however preferable for use in a portable electronic device or the like.

Methanol can conceivably be supplied in a passive manner. Passive-type DMFCs, however, require providing a sealing structure at the fuel electrode side in order to prevent methanol from leaking out.

As described above, methanol and water react at the fuel electrode (anode) side, generating carbon dioxide (g) that causes the internal pressure on the fuel electrode side to rise gradually as a result. Ultimately, the gas in the interior may leak causing methanol gas to escape out of the fuel cell. Methanol leakage is problematic not only on account of reduced fuel consumption efficiency, but also in terms of safety, and thus must be duly addressed.

The low output of DMFCs is another problem. At present, no electronic devices operate relying on a DMFC alone, and the mainstream mode of operation involves a hybrid approach where a DMFC is combined with a rechargeable secondary battery. This hybrid approach, however, must still deliver a performance such that the secondary battery is charged stably by a DMFC operating at optimum efficiency.

To realize such a performance, methanol must be supplied in such a manner that the DMFC can operate at optimum efficiency, i.e. the methanol supply rate must be adequately preserved. However, optimizing the methanol release rate has proved to be very difficult.

In the light of the above, it is an object of the present invention to provide a direct methanol fuel cell system that uses extremely safe solid-state methanol in a fuel cartridge, and that solves the problems of liquid leakage and crossover that occur when a liquid fuel is used, can adjust the methanol supply rate and can generate power efficiently without rises in the pressure of the fuel electrode as a system. Another object of the present invention is to provide a portable electronic device using the direct methanol fuel cell system.

### Means for Solving the Problem

In order to solve the above problems, the present invention provides a direct methanol fuel cell system comprising a direct methanol fuel cell; and a fuel container which is provided in the vicinity of a fuel electrode of the fuel cell, and which stores solid-state methanol resulting from making methanol into a solid state (Invention 1).

In the above invention (Invention 1), solid-state methanol is provided in the vicinity of the fuel electrode of the fuel cell, and hence power generation is supported by methanol molecules that vaporize gradually through the surface of the solid-state methanol and reach the fuel electrode.

This is thought to be accounted for by the reasons below. In the solid-state methanol, methanol is loosely bounded by intermolecular forces, such as inclusion phenomena, inside the material. As a result, methanol vaporizes gradually, not abruptly.

Therefore, solid-state methanol is provided in the vicinity of the fuel electrode of the fuel cell, so as to leave a very small gap space between the solid-state methanol and the fuel electrode in the fuel cell, and allow thereby the concentration of methanol in the space to reach rapidly the saturated vapor concentration.

Power is generated through decomposition of the vaporized methanol on the catalyst of the fuel electrode. To generate power in the fuel cell, water must be supplied to the fuel electrode in an amount equimolar to the amount of methanol. At the start of power generation the reaction proceeds using the water originally held in the electrolyte membrane. As the reaction progresses, the water generated in the reaction permeates back across the electrolyte membrane and is supplied to the fuel electrode. Power generation can take place therefore without a supply of water.

To sustain power generation, further methanol vaporizes through the surface of the solid-state methanol in such a manner so as to make up for the methanol that decomposes on the fuel electrode.

Thus, excess methanol is not supplied to the fuel electrode, and hence the direct methanol fuel cell system is free of the problems of, for instance, crossover and liquid leakage.

In the present invention, power generation has proved to take place without supply of water to the fuel electrode of the fuel cell. The reason for this seems to be that, at the start of power generation, the reaction proceeds using the water originally held in the electrolyte membrane, and as the reaction progresses, the water generated in the reaction permeates back across the electrolyte membrane and is supplied to the fuel electrode.

In the above invention (Invention 1), preferably, a film is formed on the surface of the solid-state methanol (Invention 2). The rate of vaporization of methanol out of the solid-state methanol can be controlled by forming a film on the surface of the solid-state methanol and by modifying the type and/or thickness of the film. The supply conditions of methanol into the fuel cell can be optimally controlled thereby. In such an invention (Invention 2), therefore, the rate of vaporization of methanol can be further slowed down by making the formed film thicker. In addition, the rate of vaporization of methanol can be slowed down depending on the material that forms the film. The film can thus be formed in such a manner so as to optimize the rate of vaporization of methanol, in accordance with, for instance, the usage environment and output considerations.

In the above invention (Invention 1), preferably, the solid-state methanol is stored together with a water-containing solid material in the fuel container (Invention 3). Methanol and water react in equimolar amounts at the fuel electrode of the fuel cell, but research by the inventors has revealed, however, that when the amount of water consumed is substantial, i.e. when the output of the fuel cell is increased, continued operation in that state renders insufficient the amount of water that is supplied to the fuel electrode from the air electrode by permeating back across the electrolyte membrane. Over time, this water insufficiency may cause a decrease in output that is believed to arise not only from the failed supply of the water necessary for the reaction, when water becomes insufficient at the fuel electrode, but also from a lowered electric conductivity of the electrolyte membrane. In the above invention (Invention 3), therefore, water is also in a solid state, like methanol. It becomes possible as a result to supply the water required for wetting the electrolyte and for taking part in the reaction, so that power can be generated stably even when no liquid water is present in the system. Also, using concomitantly solid-state methanol and a water-containing solid material allows power to be generated without causing a decrease in the water content in the membrane. Moreover, no liquid is held inside the system, and hence the invention has also the effect of eliminating the risk of liquid leakage.

Preferably, the above invention (Invention 1) further comprises an alkaline inorganic solid that reacts with a gas that is present between the fuel electrode of the direct methanol fuel cell and the fuel container (Invention 4).

In a passive-type direct methanol fuel cell system, the fuel electrode side must have a sealed structure in order to prevent leakage of methanol-containing gas out of the fuel electrode. Carbon dioxide is generated as the methanol is consumed in the fuel electrode, and thus the pressure in the fuel electrode rises as power generation progresses. In this situation, increasing the pressure at the fuel electrode side is likely to result in gas leakage, in which methanol leaks out of the cell. The invention (Invention 4), therefore, is provided with an alkaline inorganic solid that reacts with a gas that is present between the fuel electrode of the fuel cell and the fuel container, whereby the alkaline inorganic solid reacts with carbon dioxide, generating carbonate and water. The pressure in the fuel electrode is thereby prevented from rising.

Moreover, water is also generated in the process, and thus water can be replenished to some extent even if no liquid water is present in the system. This allows preventing a shortage of water necessary for electrolyte wetting and for the power-generating reaction, so that power can be generated stably. Moreover, no liquid is held inside the system, and hence the invention elicits also the effect of eliminating the risk of liquid leakage.

In the above inventions (Inventions 1 to 4), the fuel container has preferably no motive power for supplying fuel to the fuel cell (Invention 5). Such an invention (Invention 5) affords a compact direct methanol fuel cell system.

In the above inventions (Inventions 2 and 5), preferably, the solid-state methanol is obtained by turning a methanol aqueous solution into a solid state (Invention 6), and the solid-state methanol having a film formed thereon is stored together with a water-containing solid material in the fuel container (Invention 7).

In the above inventions (Inventions 6 and 7), stable power generation can be sustained by supplying both methanol and water, since power generation takes place in the direct methanol fuel cell system through reaction of equimolar amounts of methanol and water.

In the above inventions (Inventions 2, 5, 6 and 7), preferably, the film is formed of one, two or more materials selected from among cellulosic materials, polyvinyl alcohol-based materials and polyacrylic acid-based materials (Invention 8).

In the above invention (Invention 8), the film materials have excellent barrier properties towards methanol vapor, and are thus appropriate as materials for coating solid-state methanol.

In the above inventions (Inventions 4 and 5), preferably, the alkaline inorganic solid is stored together with the solid-state methanol in the fuel container (Invention 9).

In the above invention (Invention 9), fuel supply and carbon dioxide absorption can be carried out in the same space, and hence the system can be made more compact. Although both the solid-state methanol and the alkaline inorganic solid need to be replenished, since both are consumed, packing the solid-state methanol and the alkaline inorganic solid in the fuel container allows both to be replenished at a time simply by replacing the fuel container.

In the above invention (Invention 9), preferably, the alkaline inorganic solid is homogeneously mixed with the solid-state methanol (Invention 10). In the above invention (Invention 10) power can be generated stably since both carbon dioxide absorption and fuel release take in a substantially even manner.

In the above inventions (Inventions 4, 5, 9 and 10), preferably, the alkaline inorganic solid is calcium hydroxide (Invention 11). In such an invention (Invention 11), carbon dioxide and calcium hydroxide react in accordance with the reaction formula below.

CO₂+Ca(OH)₂→CaCO₃+H₂O [3]

As a result, water required for the reaction can be replenished at the same time that carbon dioxide is absorbed.

In the above inventions (Inventions 1 to 11), preferably, the fuel container has an air-permeable surface formed thereon, such that the air-permeable surface faces the fuel electrode side of the direct methanol fuel cell (Invention 12).

The above invention (Invention 12) allows minimizing the distance that methanol vaporized from the solid-state methanol travels up to the fuel electrode, relative to the gap between the fuel cell and the fuel container, and hence power generation can take place rapidly and with good efficiency at the fuel cell.

In the above invention (Invention 12), preferably, the air-permeable surface is divided by a permeable material through which only gaseous components can pass (Invention 13). In the above invention (Invention 13), the permeable material allows blocking off components other than methanol that are comprised in the solid-state methanol and that may degrade the electrolyte membrane when, for instance, solid-state methanol residue or the like remains in the fuel electrode. The permeable material allows preventing thereby the adverse effect of such components.

In the above inventions (Inventions 12 and 13), preferably, the water-containing solid material is localized at the air-permeable surface side of the fuel container (Invention 14). Water has a lower vapor pressure and hence a slower rate of vaporization than methanol. In such an invention (Invention 14), however, the slower rate of vaporization of water can be compensated by localizing the water-containing solid material at the air-permeable surface side in the vicinity of the fuel electrode.

In the above inventions (Inventions 12 and 13), preferably, the solid-state methanol and the water-containing solid material are stored in the fuel container partitioned from each other so as to face the air-permeable surface (Invention 15).

The above invention (Invention 15) affords a safe use, even when the water-containing solid material is so moistened that liquid water rises to the surface, since water is a safe substance. When using such a material together with the solid-state methanol, however, methanol migrates gradually into the wetting water layer, which may lead to the formation of a methanol aqueous solution inside the fuel container. Therefore, the solid-state methanol and the water-containing solid material are stored in the fuel container partitioned from each other so as to face the air-permeable surface. This arrangement allows preventing the formation of a methanol aqueous solution, so that the system can deliver a stable performance.

Further, the present invention provides a portable electronic device (Invention 16) comprising the direct methanol fuel cell system of the above inventions (Inventions 1 to 15). Such an invention (Invention 16) affords a compact portable electronic device of stable operation, by using a compact direct methanol fuel cell system capable of generating power with good efficiency, in which the methanol supply rate can be appropriately controlled, and in which the problems of crossover, liquid leakage and the like are improved.

### ADVANTAGEOUS EFFECT OF THE INVENTION

The present invention succeeds in providing a direct methanol fuel cell system capable of generating power with good efficiency, in which the methanol supply rate can be appropriately controlled, and in which the problems of crossover, liquid leakage and the like are improved. Moreover, the direct methanol fuel cell system does not require providing a device such as a water supply mechanism, and hence the invention has also the effect of making the direct methanol fuel cell system more compact.

### BRIEF DESCRIPTION OF THE DRAWINGS

FIG. 1 is a schematic diagram illustrating a direct methanol fuel cell system according to a first to fourth embodiment of the present invention;

FIG. 2 is a perspective-view diagram illustrating a solid-state methanol storage container of the direct methanol fuel cell system according to the first to fourth embodiment of the present invention;

FIG. 3 is a schematic diagram illustrating a packing state (I) of solid-state methanol and a water-containing solid material in a storage container of a direct methanol fuel cell system according to a third embodiment of the present invention;

FIG. 4 is a schematic diagram illustrating a packing state (II) of solid-state methanol and a water-containing solid material in a storage container of the direct methanol fuel cell system according to the third embodiment of the present invention;

FIG. 5 is a schematic diagram illustrating a packing state (III) of solid-state methanol and a water-containing solid material in a storage container of the direct methanol fuel cell system according to the third embodiment of the present invention;

FIG. 6 is a graph illustrating power characteristic measurement results of DMFC cells in Example 1 and Comparative example 1;

FIG. 7 is a graph illustrating power characteristic measurement results of direct methanol fuel cell systems in Example 5, Comparative example 3 and a Reference example;

FIG. 8 is a graph illustrating the change in cell voltage over time, for a constant load current, in the direct methanol fuel cell system of Example 5;

FIG. 9 is a graph illustrating the change in cell voltage over time, for a constant load current, in the direct methanol fuel cell system of the Reference example; and

FIG. 10 is a graph illustrating power characteristic measurement results of direct methanol fuel cell systems in Example 8 and Comparative example 4.

### DESCRIPTION OF THE REFERENCE NUMERALS

1 fuel cell
2 fuel electrode
3 electrolyte membrane
4 air electrode
5 solid-state methanol storage container (fuel container)
12 opening
12A synthetic resin mesh (permeable material)
21 water-containing solid material
22 solid-state methanol

### BEST MODE FOR CARRYING OUT THE INVENTION

The direct methanol fuel cell system of the present embodiment is explained in detail next with reference to accompanying drawings.

### First Embodiment

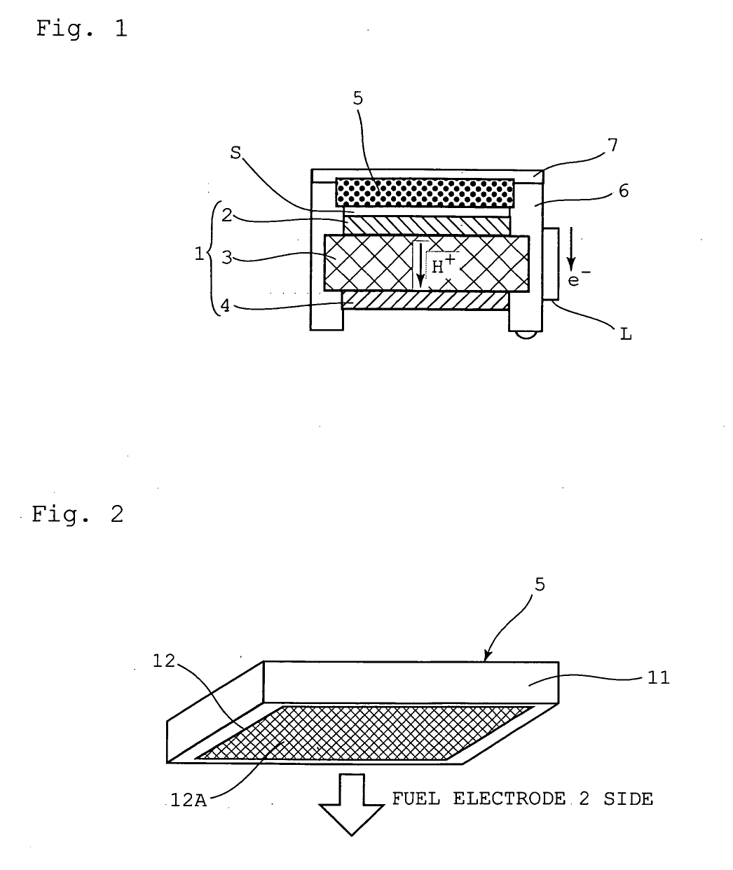

FIG. 1 is a schematic diagram illustrating a direct methanol fuel cell system according to a first embodiment of the present invention; and FIG. 2 is perspective-view diagram illustrating a solid-state methanol storage container as the fuel container in FIG. 1.

As illustrated in FIGS. 1 and 2, a fuel cell 1 comprises a fuel electrode 2, an electrolyte membrane 3 and an air electrode 4. The fuel electrode 2 and the air electrode 4 are electrically connected by way of an electric circuit L. A solid-state methanol storage container 5 serving as a fuel container is disposed in the vicinity of the fuel cell 1, on the side of the fuel electrode 2. The fuel cell 1 and the solid-state methanol storage container 5 are fixed so as to be surrounded on four sides by a frame body 6. The top face of the solid-state methanol storage container 5 is covered by an openable and closable cover 7.

The solid-state methanol storage container 5 comprises a rectangular box-like casing 11, the interior of which is packed with solid-state methanol. An opening 12 serving as an air-permeable surface is formed on the lower face side. The opening 12 is divided by a synthetic resin mesh 12A which is a permeable material. As a result, the solid-state methanol is held in the solid-state methanol storage container 5 with secured air permeability.

The permeable material has pores through which methanol and water molecules can pass, but not solid-state methanol particles. Any material can be used as the permeable material, so long as the material is not affected by methanol vapor. Other than the synthetic resin mesh 12A, the permeable material may be a polymer filter, a paper filter or some other porous material. Preferably, such a storage container 5 is used as a fuel cartridge attachable to and detachable from the frame body 6 upon opening and closing of the cover 7.

The solid-state methanol used in a direct methanol fuel cell system such as the one described above may be any substance that contains methanol and exhibits a solid state, for instance a molecular compound of methanol such as a methanol inclusion compound; solid-state methanol obtained through solidification of methanol together with a polymer or through gelling of methanol with dibenzylidene-D-sorbitol or the like; solid-state methanol in which methanol is held in a solid state through adsorption or the like onto an inorganic material such as magnesium aluminometasilicate or the like; or a coated product of any of the foregoing to adjust the vaporization temperature of methanol.

The molecular compound is a compound formed through bonding of two or more individually stable compounds by way of relatively weak interactions other than covalent bonds, typified by hydrogen bonds, Van der Waal's forces or the like. The molecular compound may be a hydrate, solvate, addition compound, inclusion compound or the like.

Such molecular compounds can be formed by way of a contact reaction of methanol with a compound that forms the molecular compound, whereby methanol can be turned into a solid-state compound. Methanol can thus be stored stably and with a comparatively low weight. Particularly preferred among the above compounds are methanol inclusion compounds resulting from a reaction between methanol and a host compound.

As the solid-state methanol there can be used also a solid-state methanol having a coating on the surface to adjust thereby the vaporization temperature of methanol.

The solid-state methanol can be used in various forms and shapes, such as sheets, blocks (chunks), particles and the like. The solid-state methanol is preferably in the form of particles. When using particles as the solid-state methanol, the rate of vaporization of methanol can be increased by reducing the size of the particles. Moreover, a small particle size promotes the mobility of the generated methanol vapor.

In terms of handleability, packing ability and gas mobility, the particle size of the solid-state methanol ranges preferably from 1 μm to 10 mm, in particular from 100 μm to 5 mm. The permeable material such as the resin mesh 12 or the like may be selected, in accordance with the form of the solid-state methanol, in such a manner that the solid-state methanol does not leak out of the solid-state methanol storage container 5.

An explanation follows next on the operation of a direct methanol fuel cell system having the above configuration.

The solid-state methanol in the casing 11 of FIG. 1 is loosely bounded by intermolecular forces, such as inclusion phenomena, inside the material. As a result, the methanol vaporizes gradually, not abruptly. The methanol molecules vaporizing gradually through the surface of the solid-state methanol reach the fuel electrode 2 of the fuel cell 1.

The clearance space S between the fuel electrode 2 and the synthetic resin mesh 12A of the storage container 5 is very small. In these conditions, therefore, the concentration of methanol in the space S reaches rapidly the saturated vapor concentration.

Power is generated as a result, in accordance with the reaction formulas below.

Anode: CH₃OH+H₂O→6H⁺+CO₂+6e⁻ [4]

Cathode: 3/2O₂+6H⁺+6e⁻→3H₂O [5]

In such a condition, the concentration of methanol in the vicinity of the fuel electrode 2 is fairly diluted, as compared with direct supply of liquid-state methanol (aqueous solution). Even when supplied as a liquid, however, methanol does not react completely at the fuel electrode 2, where only part of the methanol is decomposed, due to catalytic activity limitations. As the amount of excess methanol increases there increases also the amount of methanol that crosses over to the air electrode 4.

Therefore, a high concentration of methanol at the fuel electrode 2 is not necessarily advantageous. An output comparable to that of liquid-feed systems can be achieved just with the methanol vaporized out of the solid-state methanol, so long as the concentration of methanol in the space S is at the saturated vapor concentration.

Methanol molecules go on vaporizing out of the solid-state methanol so as to make up for the methanol that is consumed through decomposition on the catalyst of the fuel electrode 2. The above-described power generating reaction is sustained thereby.

Reaction formula [4] shows that water is required in an amount equimolar to the amount of methanol. In the present embodiment, however, water is not an essential prerequisite. This is thought to be accounted for by the reasons below.

At the start of power generation, the reaction is initiated at the fuel electrode 2 by utilizing the water originally held in the electrolyte membrane 3. As the reaction progresses, the water generated at the air electrode 4 according to reaction formula [5] permeates back across the electrolyte membrane 3 and is supplied to the fuel electrode 2. To ensure reliable early power generation, the fuel electrode 2 may contain some water beforehand.

### Second Embodiment

The configuration of the direct methanol fuel cell system according to a second embodiment of the present invention is similar to that of the direct methanol fuel cell system according to the first embodiment, except that herein a film is formed on the surface of the solid-state methanol. Elements similar to those of the first embodiment will be denoted with identical reference numerals, and a detailed explanation thereof will be omitted.

In the second embodiment, a film is formed on the surface of the solid-state methanol. This allows controlling the vaporization of the methanol held in a base material such as a porous material or a gel that is in turn confined within the formed film. Methods for forming a film on the surface of solid-state methanol include, for instance, bringing the solid-state methanol into contact with a coating agent.

Preferred examples of the coating agent include polymer materials having film-forming action, for instance, cellulosic materials such as methyl cellulose, ethyl cellulose, hydroxyethyl cellulose, hydroxypropyl cellulose, hydroxypropylmethyl cellulose, hydroxyethylmethyl cellulose, carboxymethyl cellulose, hydroxypropylmethyl cellulose acetate succinate and the like; water-soluble polymers (polyvinyl alcohol)-based materials such as polyvinyl alcohol (PVA); and polymers soluble both in water and alcohols, such as polyvinyl pyrrolidone (PVP), as well as polyacrylic acid-based materials. The foregoing may be used singly or in combinations of two or more.

Preferably used among the above coating agents are cellulose derivatives and/or PVA, in particular cellulose derivatives. Many cellulose derivatives are used, for instance, as binding materials for tablets and granules, matrix bases for sustained-release tablets, jellies or the like, in the medical field, and are also used in the food industry as thickener/gelling agents, film coating agents for health foods, capsule agents or shape-loss preventing agents in fries and pancakes. Cellulose derivatives boast thus proven safety for humans, and are hence appropriate in terms of safety, also in case of accidental ingestion by infants.

Methods for forming a film on the surface of the solid-state methanol by bringing into contact the solid-state methanol with a coating agent include, but not limited thereto, fluidized bed coating, coating by combined rolling and fluidizing, drum coating, pan coating and the like. Coating system may involve film coating, sugar coating or the like, but preferably film coating, from the viewpoint of making the formed coating film as thin as possible, thereby increasing the methanol content in the solid-state methanol.

The blending amount of the coating agent ranges preferably from 0.0001 to 0.5 parts by weight relative to 1 part by weight of a solid-state methanol molding. The coating film can be effectively formed on the surface of the solid-state methanol molding, to a desired thickness, when the blending amount of coating agent falls within the above range.

Such a solid-state methanol having a film formed thereon comprises preferably 1 to 3 parts by weight of methanol taken up in 1 part by weight of base material. When the film-coated solid-state methanol is obtained by introducing water and methanol into a porous material, the film-coated solid-state methanol comprises preferably a total 1 to 3 parts by weight of methanol and water taken up in 1 part by weight of base material.

At normal temperature, methanol vaporizes gradually out of the film-coated solid-state methanol manufactured in accordance with the present embodiment. Depending on the circumstances, vaporization of methanol can be promoted by means of, for instance, a heating mechanism or a mechanism for imparting vibrational energy. Examples of heating mechanisms include, for instance, heaters and Peltier elements, while examples of mechanisms for imparting vibrational energy include, for instance, ultrasonic generators, piezoelectric elements or the like.

An explanation follows next on the operation of a direct methanol fuel cell system having the above configuration.

The film-coated solid-state methanol in the casing 11 of FIG. 1 is loosely bounded by intermolecular forces, such as inclusion phenomena, inside the material. As a result, methanol vaporizes gradually, not abruptly. The rate of vaporization of the methanol is adjusted to a desired value by appropriately setting beforehand the material and thickness of the coating film. The methanol molecules vaporizing gradually out of the surface of the film-coated solid-state methanol reach the fuel electrode 2 of the fuel cell 1.

The clearance space S between the fuel electrode 2 and the synthetic resin mesh 12A of the storage container 5 is very small. In these conditions, therefore, the concentration of methanol in the space S reaches rapidly the saturated vapor concentration.

Power is generated as a result, in accordance with the reaction formulas below.

Anode: CH₃OH+H₂O→6H⁺+CO₂+6e⁻ [6]

Cathode: 3/2O₂+6H⁺+6e⁻→3H₂O [7]

In such a condition, the concentration of methanol in the vicinity of the fuel electrode 2 is fairly diluted, as compared with direct supply of liquid-state methanol (aqueous solution). Even when supplied as a liquid, however, methanol does not react completely at the fuel electrode 2, where only part of the methanol is decomposed, due to catalytic activity limitations. As the amount of excess methanol increases there increases also the amount of methanol that crosses over to the air electrode 4.

Therefore, a high concentration of methanol at the fuel electrode 2 is not necessarily advantageous. An output comparable to that of liquid-feed systems can be achieved just with the methanol vaporized out of the film-coated solid-state methanol, so long as the concentration of methanol in the space S is at the saturated vapor concentration.

Methanol molecules go on vaporizing out of the film-coated solid-state methanol so as to make up for the methanol that is consumed through decomposition on the catalyst of the fuel electrode 2. The above-described power generating reaction is sustained thereby.

Reaction formula [6] shows that water is required in an amount equimolar to the amount of methanol. In the present embodiment, however, water is not an essential prerequisite. This is thought to be accounted for by the reasons below.

At the start of power generation, the reaction is initiated at the fuel electrode 2 by utilizing the water originally held in the electrolyte membrane 3. As the reaction progresses, the water generated at the air electrode 4 according to reaction formula [7] permeates back across the electrolyte membrane 3 and is supplied to the fuel electrode 2. To ensure reliable early power generation, the fuel electrode 2 may contain some water beforehand.

### Third Embodiment

The configuration of the direct methanol fuel cell system according to the third embodiment of the present invention is similar to that of the direct methanol fuel cell system according to the first embodiment, except that herein the storage container 5 is packed with both solid-state methanol and a water-containing solid material. Elements similar to those of the first embodiment will be denoted with identical reference numerals, and a detailed explanation thereof will be omitted.

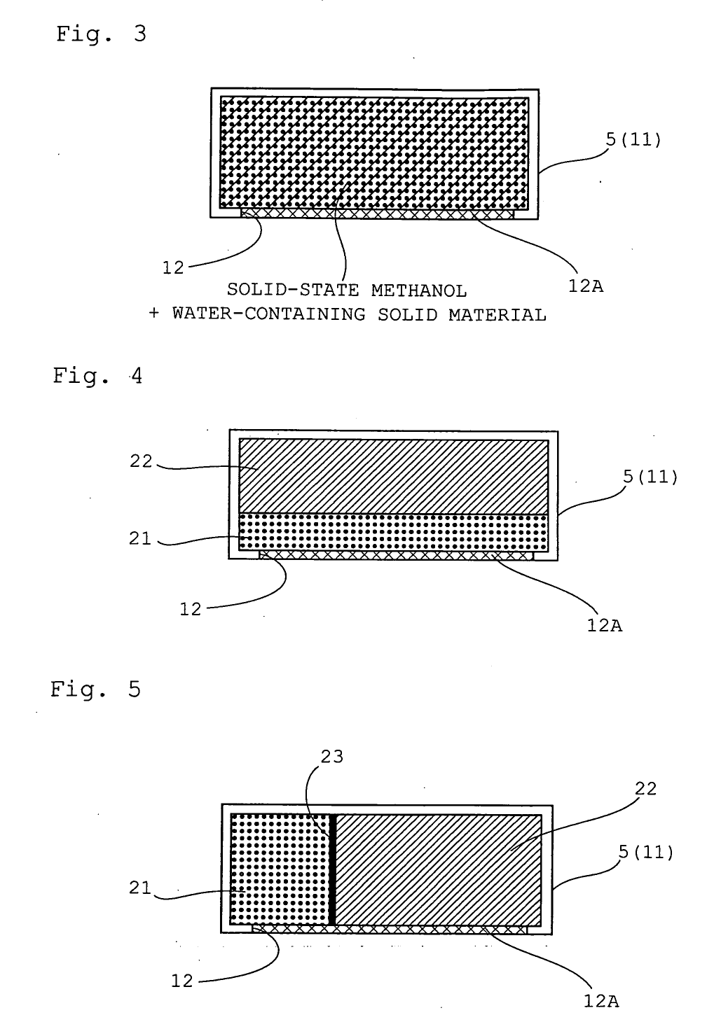

In the third embodiment, the storage container 5 comprises a rectangular box-like casing 11, the interior of which is packed with solid-state methanol resulting from making methanol into a solid state, and with a water-containing solid material. An opening 12 formed on the lower face side of the storage container 5 is divided by a synthetic resin mesh 12A. The solid-state methanol and water-containing solid material are thus held in a homogeneously mixed state, with secured air permeability as shown in FIG. 3.

As the base material of the water-containing solid material, which should be capable of confining water to a degree such that no liquid water leaks out of the material, there can be used be for instance an inorganic porous material such as magnesium aluminometasilicate, an organic porous material, a fibrous material, a water-absorbing polymer material or the like. Although not limited thereto, specific examples of the foregoing include, for instance, inorganic porous materials such as silica or titania, activated carbon, porous glass, fibrous materials such as glass fibers, ordinary fabrics and paper, cellulose fibers, polyamide-based water-absorbing resins and the like. The water-containing solid material may be coated, to adjust thereby the vaporization temperature of water.

The water-containing solid material comprises preferably 1 to 4 parts by weight of water taken up in 1 part by weight of base material. The solid-state methanol and the water-containing solid material may coexist within a same solid substance (particles, sheets, blocks or the like). Herein there can be used, for instance, particles resulting from granulating a mixture of solid-state methanol particles and water.

As regards the proportion of solid-state methanol and water-containing solid material in the storage container 5, water must theoretically be present in a stoichiometric amount (equimolar amount) to the amount of methanol comprised in the total solid-state methanol. In actual operation, however, the system can go on functioning stably with an amount of water smaller than the stoichiometric amount, presumably because the stoichiometric shortfall of water is made up for by water generated at the air electrode and which diffuses back into the fuel electrode.

Therefore, the water-containing solid material may be packed in such a manner that the amount of water ranges from 0.1 to 1.0 (mol/mol), preferably from 0.2 to 0.5 (mol/mol), relative to the amount of methanol comprised in the total solid-state methanol. However, an excess of water-containing solid material reduces the space that could be packed with solid-state methanol in the fuel container 5, and hence the blending amount of water-containing material is preferably as small as possible.

An explanation follows next on the operation of a direct methanol fuel cell system having the above configuration.

The solid-state methanol in the casing 11 of FIG. 1 is loosely bounded by intermolecular forces, such as inclusion phenomena, inside the material. As a result, methanol vaporizes gradually, not abruptly. Water vaporizes gradually as well out of the water-containing solid material. The methanol molecules vaporizing gradually through the surface of the solid-state methanol and the water molecules vaporizing gradually through the surface of the water-containing solid material reach the fuel electrode 2 of the fuel cell 1.

The clearance space S between the fuel electrode 2 and the synthetic resin mesh 12A of the storage container 5 is very small. In these conditions, therefore, the concentration of methanol in the space S reaches rapidly the saturated vapor concentration.

Power is generated as a result, in accordance with the reaction formulas below.

Anode: CH₃OH+H₂O→6H⁺+CO₂+6e⁻ [8]

Cathode: 3/2O₂+6H⁺+6e⁻→3H₂O [9]

In such a condition, the concentration of methanol in the vicinity of the fuel electrode 2 is fairly diluted, as compared with direct supply of liquid-state methanol (aqueous solution). Even when supplied as a liquid, however, methanol does not react completely at the fuel electrode 2, where only part of the methanol is decomposed, due to catalytic activity limitations. As the amount of excess methanol increases there increases also the amount of methanol that crosses over to the air electrode 4.

Therefore, a high concentration of methanol at the fuel electrode 2 is not necessarily advantageous. An output comparable to that of liquid-feed systems can be achieved just with the methanol vaporized out of the solid-state methanol, so long as the concentration of methanol in the space S is at the saturated vapor concentration.

Methanol molecules go on vaporizing out of the solid-state methanol so as to make up for the methanol that is consumed through decomposition on the catalyst of the fuel electrode 2. The above-described power generating reaction is sustained thereby.

Reaction formula [8] shows that water is required in an amount equimolar to the amount of methanol. As described above, the reaction is initiated using the water vaporizing out of the water-containing solid material and the water originally held in the electrolyte membrane 3. As the reaction progresses, the water generated at the air electrode 4 according to reaction formula [9] permeates back across the electrolyte membrane 3 and is supplied to the fuel electrode 2. Therefore, the water in the water-containing solid material may be less than equimolar. To ensure reliable early power generation, the fuel electrode 2 may contain some water beforehand.

### Fourth Embodiment

The configuration of the direct methanol fuel cell system according to a fourth embodiment of the present invention is similar to that of the direct methanol fuel cell system according to the first embodiment, except that herein the storage container 5 is packed with solid-state methanol and an alkaline inorganic solid. Elements similar to those of the first embodiment will be denoted with identical reference numerals, and a detailed explanation thereof will be omitted.

In the fourth embodiment, the storage container 5 comprises a rectangular box-like casing 11, the interior of which is packed with solid-state methanol and an alkaline inorganic solid. An opening 12 formed on the lower face side of the storage container 5 is divided by a synthetic resin mesh 12A as a permeable material. As a result, the solid-state methanol and the alkaline inorganic solid are held in a homogeneously mixed state, with secured air permeability.

Hydroxides of alkali metals and oxides or hydroxides of alkaline earth metals, among others, fall under the category of alkaline inorganic solids. From the viewpoint of safety, for instance, there is preferably used an oxide or hydroxide of an alkaline earth metal, such as calcium oxide, calcium hydroxide, magnesium hydroxide or the like. Preferably, the alkaline inorganic solid is in the form of a powder. In terms of handleability, the particle size of the alkaline inorganic solid ranges preferably from 1 μm to 10 mm, and in particular from 1 μm to 100 μm, in terms of reactivity with carbon dioxide.

The permeable material such as the synthetic resin mesh 12A may be appropriately selected and used depending on the solid-state methanol and the alkaline inorganic solid, in such a manner that these do not spill out.

As regards the proportion of solid-state methanol and alkaline inorganic solid in the storage container 5, carbon dioxide is generated in a stoichiometric amount (equimolar amount) to the amount of methanol comprised in the total solid-state methanol. Hence, the alkaline inorganic solid should theoretically be needed also in a stoichiometric amount (equimolar amount). In practice, however, the amount of alkaline inorganic solid ranges from 0.05 to 1 equivalent, preferably from 0.1 to 0.5 equivalents, relative to the theoretical carbon dioxide amount. The fact that it is acceptable for the amount of alkaline inorganic solid to be smaller than the theoretical carbon dioxide amount is attributable to the release of CO₂ into the air electrode 4, through the electrolyte membrane 3, and to the absorption of CO₂ in voids within the material of the solid-state methanol, all of which renders the amount of carbon dioxide smaller than the theoretical one. However, an excess of alkaline inorganic solid reduces the space that could be packed with solid-state methanol, and hence the blending amount of alkaline inorganic solid is preferably as small as possible.

An explanation follows next on the operation of a direct methanol fuel cell system having the above configuration.

The solid-state methanol in the casing 11 of FIG. 1 is loosely bounded by intermolecular forces, such as inclusion phenomena, inside the material. As a result, methanol vaporizes gradually, not abruptly. The methanol molecules vaporizing gradually through the surface of the solid-state methanol reach the fuel electrode 2 of the fuel cell 1.

The clearance space S between the fuel electrode 2 and the synthetic resin mesh 12A of the storage container 5 is very small. In these conditions, therefore, the concentration of methanol in the space S reaches rapidly the saturated vapor concentration.

Power is generated as a result, in accordance with the reaction formulas below.

Anode: CH₃OH+H₂O→6H⁺+CO₂+6e⁻ [10]

Cathode: 3/2O₂+6H⁺+6e⁻→3H₂O [11]

In such a condition, the concentration of methanol in the vicinity of the fuel electrode 2 is fairly diluted, as compared with direct supply of liquid-state methanol (aqueous solution). Even when supplied as a liquid, however, methanol does not react completely at the fuel electrode 2, where only part of the methanol is decomposed, due to catalytic activity limitations. As the amount of excess methanol increases there increases also the amount of methanol that crosses over to the air electrode 4.

Therefore, a high concentration of methanol at the fuel electrode 2 is not necessarily advantageous. An output comparable to that of liquid-feed systems can be achieved just with the methanol vaporized out of the solid-state methanol, so long as the concentration of methanol in the space S is at the saturated vapor concentration.

Methanol molecules go on vaporizing out of the solid-state methanol so as to make up for the methanol that is consumed through decomposition on the catalyst of the fuel electrode 2. The above-described power generating reaction is sustained thereby.

In reaction formula [10] above, the reaction of methanol and water yields carbon dioxide gas in an amount equimolar to the amount of methanol. This carbon dioxide gas passes through the synthetic resin mesh 12A and diffuses into the solid-state methanol storage container 5. The carbon dioxide gas is absorbed by the alkaline inorganic solid, for instance calcium hydroxide, in the solid-state methanol storage container 5, in accordance with the reaction formula below.

CO₂+Ca(OH)₂→CaCO₃+H₂O [12]

In the above reaction water is formed in an amount equimolar to the amount of CO₂.

Therefore, the reaction is initiated by water held initially in the electrolyte membrane 3. As the reaction progresses, the water generated at the air electrode 4 according to reaction formula [11] permeates back across the electrolyte membrane 3. At the same time, CO₂ and the alkaline inorganic solid react in accordance with reaction formula [12] to yield water that is likewise supplied so that the power-generating reaction can be continued with good efficiency. The amount of water generated through reaction of CO₂ and the alkaline inorganic solid may be therefore smaller than an equimolar amount relative to methanol. To ensure reliable early power generation, however, the fuel electrode 2 contains preferably some water beforehand.

The present invention has been explained on the basis of embodiments. The invention, however, is not limited to these embodiments, and may be modified in numerous ways. For instance, the solid-state methanol used need not be 100% pure methanol made into a solid state, and may be a methanol aqueous solution of desired concentration, resulting from adding water to methanol, and made subsequently into solid state. A means for promoting the release of methanol vapor from the solid-state methanol may also be provided in the storage container 5, as the case may require. Specific examples of such a means include, for instance, heating equipment, or a vibrational energy generator such as an ultrasonic or piezoelectric element.

In the second embodiment the film-coated solid-state methanol may be concomitantly used with a water-containing solid material. In this case, the film-coated solid-state methanol may be mixed with the water-containing solid material in the storage container 5. Alternatively, a layer of the water-containing solid material may be formed on the side of the fuel electrode 2 (opening 12), with a layer of the film-coated solid-state methanol being formed on the water-containing solid material layer.

In the third embodiment, for instance, the solid-state methanol and the water-containing solid material are preferably distributed in such a manner that the water-containing solid material 21 is localized at the side of the opening 12 of the storage container 5 in the vicinity of the fuel electrode 2, while the solid-state methanol 22 is localized at the opposite side, as illustrated in FIG. 4. Since water has a lower vapor pressure and hence a slower rate of vaporization than methanol, supply of water tends to be insufficient. However, the slower rate of vaporization of water can be compensated by using the above configuration, in which the water-containing solid material 21 is localized close to the fuel electrode 2. This allows also keeping to a minimum the blending amount of the water-containing solid material 21.

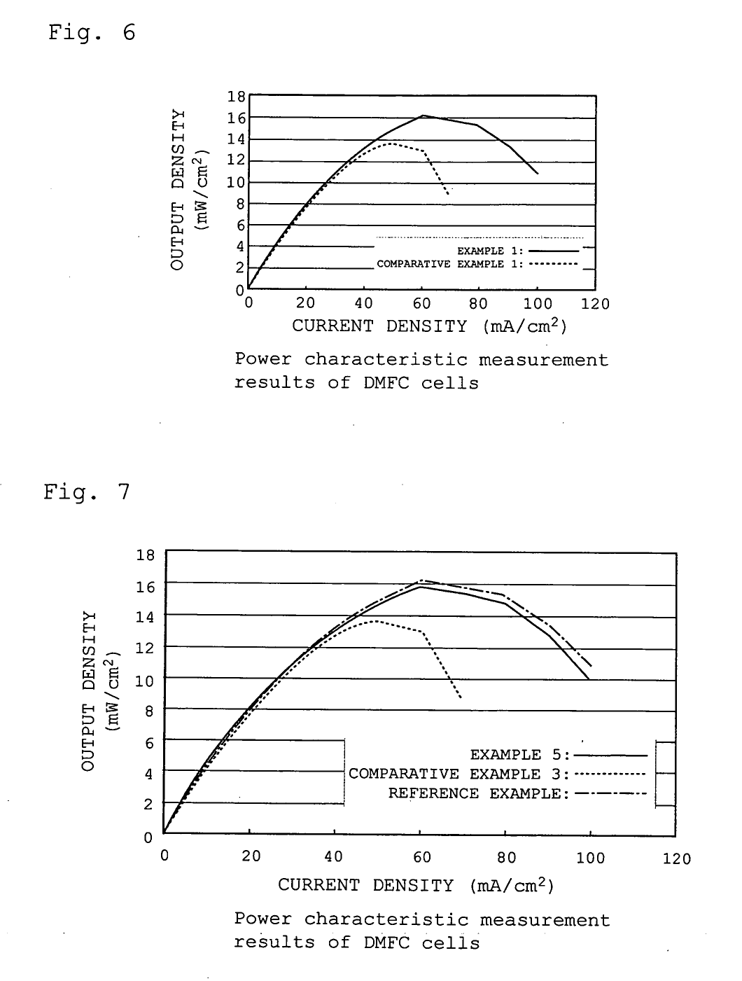

The solid-state methanol 22 and the water-containing solid material 21 may be stored in such a manner that both face the opening 12, but with a partition wall 23 provided between the solid-state methanol 22 and the water-containing solid material 21, as illustrated in FIG. 5. This configuration allows preventing formation of an aqueous solution of methanol in the solid-state methanol 22 inside the fuel container 5 through wetting by water, even when the water-containing solid material 21 becomes so moistened, through an increase of the water content, that liquid water raises to the surface. Stable performance can be delivered as a result. The water content of the water-containing solid material 21 can be increased, which allows keeping to a minimum the blending amount of water-containing solid material 21.

The direct methanol fuel cell system of the present invention, as described above, requires no motive power for fuel supply, such as a fuel supply pump or the like, and can thus be constructed in a compact manner. The direct methanol fuel cell system of the present invention is therefore particularly suitable as a power source for portable electronic devices.

### EXAMPLES

The present invention is explained in more detail based on the examples below. Unless departing from the scope thereof, the present invention is not meant in any way to be limited to or by the following examples.

### Example 1

### Fuel Cell

The specifications of the fuel cell used for testing were as follows.

MEA: MEA for DMFCs by Chemix Inc.
Electrolyte membrane: Nafion 117 (by DuPont)
Anode catalyst: Pt—Ru/C
Cathode catalyst: Pt/C
Effective membrane area: 16 cm²

Collector material: SUS mesh (Au-plated)

Fuel electrode: sealed structure (fuel can flow in/out through opening/closing of the upper lid)

Air electrode: open structure

[Preparation of Solid-State Methanol]

A methanol inclusion compound was prepared by dissolving under heating, and then recrystallizing, 39.8 g (0.1 mol) of 1,1,2,2-tetrakis(4-hydroxyphenyl)ethane (THPE) in 100 mL of methanol, to yield solid-state methanol having a methanol content of 14 wt %, at a THPE:methanol ratio (mole ratio) of 1:2.

[Direct Methanol Fuel Cell System]

A storage container 5 was manufactured next by packing 8 g of the methanol inclusion compound into the box-like container illustrated in FIG. 2 having 40×40×10 dimensions (mm), and by spreading a nonwoven fabric, as the permeable material, over the face of the container opposite the fuel electrode 2, to prevent the methanol inclusion compound from leaking out.

The fuel electrode 2 of the fuel cell 1 that was used had been moistened beforehand through soaking with pure water. The pure water was drained before the test and the water droplets were removed under a nitrogen gas stream. To obtain a direct methanol fuel cell system (Example 1), the fuel cell 1 was mounted in the device illustrated in FIG. 1, the storage container 5 was mounted at the side of the fuel electrode 2, and then the cover 7 was closed, to seal the whole. The gap formed between the fuel electrode 2 and the nonwoven fabric of the storage container 5 was of 5 mm.

### Example 2

### Preparation of Film-Coated Solid-State Methanol

Solid-state methanol particles were obtained by blending hydroxypropyl cellulose (2 g) and methanol (230 g) with magnesium aluminometasilicate powder (100 g) and by granulating the blend, using a granulator, into spherical particles having a diameter of about 3 mm.

To prepare film-coated solid-state methanol particles, the solid-state methanol particles were charged into a coating apparatus, and were dried therein through blowing of a 0.5% methanol solution of ethyl cellulose for 5 minutes at a flow rate of 10 mL/min, to form thereby an ethyl cellulose film, about 30 μm thick, on the surface of the solid-state methanol particles. The methanol content of the film-coated solid-state methanol particles was about 65%.

[Direct Methanol Fuel Cell System]

A storage container 5 was manufactured next by packing 8 g of the film-coated solid-state methanol particles into the box-like container illustrated in FIG. 2 having 40×40×10 dimensions (mm), and by spreading a nonwoven fabric, as the permeable material, over the face of the container opposite the fuel electrode 2, to prevent the film-coated solid-state methanol particles from leaking out.

The fuel electrode 2 of the fuel cell 1 described in Example 1 had been moistened beforehand through soaking with pure water. The pure water was drained before the test and the water droplets were removed under a nitrogen gas stream. To obtain a direct methanol fuel cell system (Example 2), the fuel cell 1 was mounted in the device illustrated in FIG. 1, the storage container 5 was mounted at the side of the fuel electrode 2, and then the cover 7 was closed, to seal the whole. The gap formed between the fuel electrode 2 and the nonwoven fabric of the storage container 5 was of 5 mm.

### Example 3

To prepare film-coated solid-state methanol particles, the solid-state methanol particles manufactured in Example 2 were charged into a coating apparatus, and were dried therein through blowing of a 0.5% methanol solution of ethyl cellulose for 10 minutes at a flow rate of 10 mL/min, to form thereby an ethyl cellulose film, about 60 μm thick, on the surface of the solid-state methanol particles. The methanol content of the film-coated solid-state methanol particles was about 62%.

A direct methanol fuel cell system (Example 3) was manufactured in the same way as in Example 2 but packing herein 8 g of the film-coated solid-state methanol particles into the box-like container illustrated in FIG. 2.

### Example 4

To prepare film-coated solid-state methanol particles, the solid-state methanol particles manufactured in Example 2 were charged into a coating apparatus, and were dried therein through blowing of a 0.5% methanol solution of ethyl cellulose for 20 minutes at a flow rate of 10 mL/min, to form thereby an ethyl cellulose film, about 120 μm thick, on the surface of the solid-state methanol particles. The methanol content of the film-coated solid-state methanol particles was about 57%.

A direct methanol fuel cell system (Example 4) was manufactured in the same way as in Example 2 but packing herein 8 g of the film-coated solid-state methanol particles into the box-like container illustrated in FIG. 2.

### Example 5

### Preparation of Solid-State Methanol

A methanol inclusion compound was prepared by dissolving under heating, and then recrystallizing, 39.8 g (0.1 mol) of 1,1,2,2-tetrakis(4-hydroxyphenyl)ethane (THPE) in 100 mL of methanol, to yield solid-state methanol having a methanol content of 14 wt %, at a THPE:methanol ratio (mole ratio) of 1:2.

[Preparation of a Water-Containing Solid Material]

Magnesium aluminometasilicate powder (50 g) and water (50 g) were thoroughly mixed under stirring to yield water-containing solid material particles having a water content of 50%.

[Direct Methanol Fuel Cell System]

A storage container 5 was manufactured next by packing 3.8 g of the methanol inclusion compound and 0.2 g of the water-containing solid material particles into the box-like container illustrated in FIG. 2 having 40×40×10 dimensions (mm), and by spreading a nonwoven fabric, as the permeable material, over the face of the container opposite the fuel electrode 2, to prevent the methanol inclusion compound from leaking out. The ratio methanol to water was 0.54 g (16.6 mol):0.10 g (5.6 mol).

The fuel electrode 2 of the fuel cell 1 described in Example 1 had been moistened beforehand through soaking with pure water. The pure water was drained before the test and the water droplets were removed under a nitrogen gas stream. To obtain a direct methanol fuel cell system (Example 5), the fuel cell 1 was mounted in the device illustrated in FIG. 1, the storage container 5 was mounted at the side of the fuel electrode 2, and then the cover 7 was closed, to seal the whole. The gap formed between the fuel electrode 2 and the nonwoven fabric of the storage container 5 was of 5 mm.

### Example 6

A direct methanol fuel cell system (Example 6) was manufactured in the same way as in Example 5, but herein 0.2 g of the water-containing solid material particles were packed on the opening side (fuel electrode 2 side) of the storage container 5, while 3.8 g of the methanol inclusion compound were packed on the opposite side, as illustrated in FIG. 4.

### Example 7

A direct methanol fuel cell system (Example 7) was manufactured in the same way as in Example 5, but with a partition wall 23 provided in the storage container 5, such that 3.8 g of the methanol inclusion compound were packed on one side of the partition wall, and 0.2 g of the water-containing solid material particles were packed on the other side, facing the opening as illustrated in FIG. 5.

### Example 8

### Preparation of Solid-State Methanol

A methanol inclusion compound was prepared by dissolving under heating, and then recrystallizing, 39.8 g (0.1 mol) of 1,1,2,2-tetrakis(4-hydroxyphenyl)ethane (THPE) in 100 mL of methanol, to yield solid-state methanol having a methanol content of 14 wt %, at a THPE:methanol ratio (mole ratio) of 1:2.

[Alkaline Inorganic Solid]

Calcium hydroxide having an average particle size of 12 μm was prepared as the alkaline inorganic solid.

[Direct Methanol Fuel Cell System]

A storage container 5 was manufactured next by packing a homogeneous mixture of 6 g of the obtained methanol inclusion compound and 1.94 g of calcium hydroxide (1.0 times the theoretical equivalent) into the box-like container illustrated in FIG. 2 having 40×40×10 dimensions (mm), and by spreading a nonwoven fabric, as the permeable material, over the face of the container opposite the fuel electrode 2, to prevent the methanol inclusion compound from leaking out.

The fuel electrode 2 of the fuel cell 1 described in Example 1 had been moistened beforehand through soaking with pure water. The pure water was drained before the test and the water droplets were removed under a nitrogen gas stream. To obtain a direct methanol fuel cell system (Example 8), the fuel cell 1 was mounted in the device illustrated in FIG. 1, the storage container 5 was mounted at the side of the fuel electrode 2, and then the cover 7 was closed, to seal the whole. The gap formed between the fuel electrode 2 and the nonwoven fabric of the storage container 5 was of 5 mm.

### Example 9

A direct methanol fuel cell system (Example 9) was manufactured in the same way as in Example 8, but herein the storage container 5 was packed with a homogenous mixture of 6 g of the methanol inclusion compound and 0.97 g (0.5 times the theoretical equivalent) of calcium hydroxide.

### Example 10

A direct methanol fuel cell system (Example 10) was manufactured in the same way as in Example 8, but herein the storage container 5 was packed with a homogenous mixture of 6 g of the methanol inclusion compound and 0.39 g (0.2 times the theoretical equivalent) of calcium hydroxide.

### Comparative Example 1

A direct methanol fuel cell system (Comparative example 1) was manufactured in the same way as in Example 1, but herein 10 mL of a 3% methanol solution was supplied to the fuel electrode 2 of the fuel cell 1, instead of using the storage container 5 packed with a methanol inclusion compound.

### Comparative Example 2

A methanol-impregnated solid powder was prepared by blending magnesium aluminometasilicate powder (100 g) and methanol (230 g) and by thoroughly mixing the blend. The methanol content in the resulting material was about 70%.

A direct methanol fuel cell system (Comparative example 2) was manufactured in the same way as in Example 2 but herein the box-like container illustrated in FIG. 2 was packed with 8 g of the obtained solid powder.

### Comparative Example 3

A direct methanol fuel cell system (Comparative example 3) was manufactured in the same way as in Example 5 but herein the storage container 5 was packed with a 3% methanol aqueous solution, instead of with 3.8 g of the methanol inclusion compound and 0.2 g of the water-containing solid material particles.

### Comparative Example 4

A direct methanol fuel cell system (Comparative example 4) was manufactured in the same way as in Example 8, but herein the storage container 5 was packed with 10 g of a 3% methanol aqueous solution, instead of with methanol inclusion compound and calcium hydroxide.

### Reference Example

A direct methanol fuel cell system (Reference example) was manufactured in the same way as in Example 5 but herein the storage container 5 was packed with a 4.0 g of the methanol inclusion compound instead of with 3.8 g of the methanol inclusion compound and 0.2 g of the water-containing solid material particles.

[Power Generation Test]

Using an electronic load device, current was made to flow through the direct methanol fuel cell systems of Examples 1 to 10, Comparative examples 1 to 4 and the Reference example, to measure fuel cell characteristics.

FIG. 6 depicts a graph of the measurement results for Example 1 and Comparative example 1, in which the abscissa axis represents load current density (mA/cm², value resulting from dividing load current by the effective membrane area of the MEA), and the ordinate axis represents the output density of the cell (mW/cm², product of the load current density by the voltage value (V) between the fuel electrode and the air electrode).

As the results illustrated in FIG. 6 clearly show, cell voltage was stable during measurement in the fuel cell system of Example 1, and maximum output was about 16 mW/cm². The concentration of formaldehyde in the gas in the vicinity of the air electrode 4, as measured using a detector tube, was less than 0.05 ppm (below the detection limit), for a density current of 40 mA/cm².

Although cell voltage was stable in the system of Comparative example 1, maximum output was low, of about 14 mW/cm², and current density was likewise poor. Moreover, the concentration of formaldehyde in the gas in the vicinity of the air electrode 4, as measured using a detector tube, was slight, of 0.1 ppm, for a density current of 40 mA/cm². This finding can be presumably attributed to the occurrence of crossover.

The measurement results for Examples 2 to 4 and Comparative example 2 are summarized in Table 1 together with cell voltage at maximum output and load current density at maximum output.

TABLE 1

| | Cell voltage | Load current | Maximum | Fuel cell |
|---|---|---|---|---|
| | at maximum | density at maximum | output | temperature |
| | output (V) | output (mA/cm²) | (mW/cm²) | (° C.) |
| Example 2 | 0.291 | 55 | 16 | 52 |
| Example 3 | 0.283 | 60 | 17 | 40 |
| Example 4 | 0.250 | 40 | 10 | 36 |
| Comp. | 0.289 | 45 | 13 | 60 |
| example 2 | | | | |

As Table 1 shows, the fuel cell system of Example 2 exhibited a maximum output of 16 mW/cm² and a fuel cell temperature of 52° C., while the fuel cell system of Example 3 exhibited a maximum output of 17 mW/cm² and a fuel cell temperature of 40° C. The fuel cell system of Example 4 exhibited a maximum output of 10 mW/cm² and a fuel cell temperature of 36° C. By contrast, the fuel cell system of Comparative example 2 exhibited a maximum output of 13 mW/cm² and a fuel cell temperature of 60° C. Crossover of methanol, arising from the supply of high-concentration methanol vapor, is thought to be behind this heat generation in the fuel cell, since the crossover methanol undergoes an exothermic oxidation reaction in the air electrode. The differences in maximum output between the examples are believed to stem from differences in the vaporization temperature of methanol in the film-coated solid-state methanol particles, i.e. from differences in the supply rate of methanol.

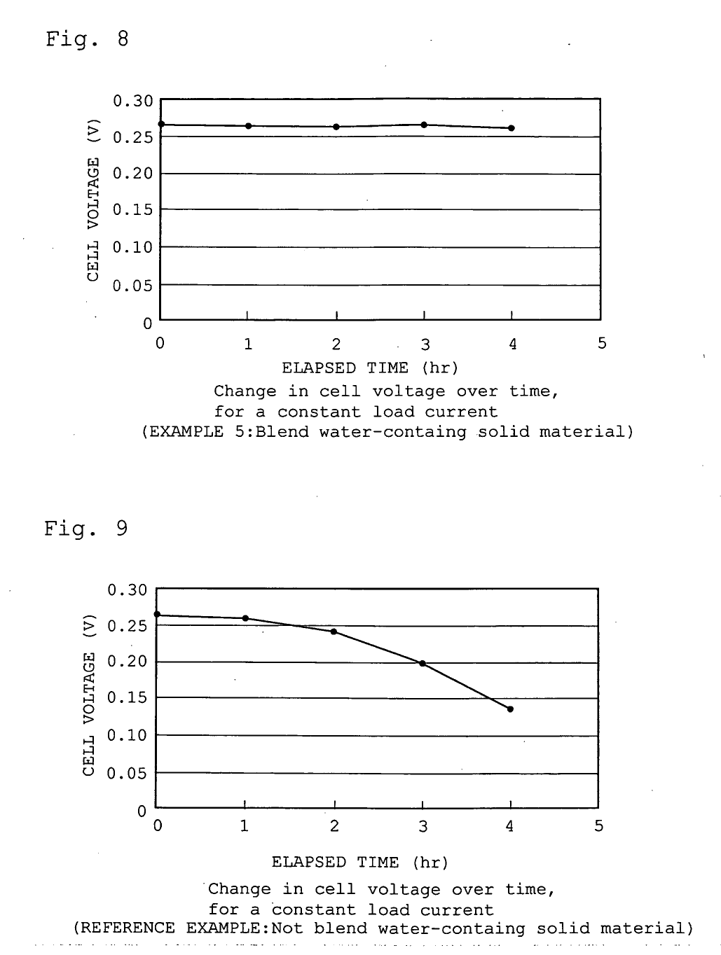

FIG. 7 depicts a graph of the measurement results for Example 5, Comparative example 3 and the Reference example, in which the abscissa axis represents load current density (mA/cm², value resulting from dividing load current by the effective membrane area of the MEA), and the ordinate axis represents the output density of the cell (mW/cm², product of the load current density by the voltage value (V) between the fuel electrode and the air electrode).

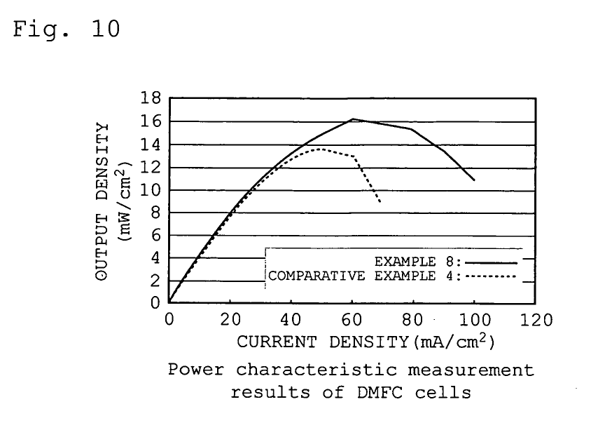

The change in cell voltage over time, for a constant load current, was measured in the direct methanol fuel cell systems of Example 5 and the Reference example. The results are depicted in FIG. 8 and FIG. 9.

In the direct methanol fuel cell system of Example 5, cell voltage was stable during measurement and maximum output was about 16 mW/cm², as illustrated in FIGS. 7 to 9. Moreover, there was virtually no drop in output after 4 hours of operation in that state.

In the direct methanol fuel cell system of Comparative example 3, where a methanol solution was supplied, cell voltage was stable during measurement but, by contrast, maximum output was low, of about 14 mW/cm², and current density was likewise poor, presumably on account of crossover.

The direct methanol fuel cell system of the Reference example, in which no water-containing solid material was packed, exhibited stable voltage during measurement and a high maximum output, of about 16 mW/cm². However, continued current load resulted in a gradual decrease of cell voltage, with a drop in output of about 50% after 4 hours. This drop in output is thought to arise from a shortage of water necessary for the reaction as water becomes insufficient over time, and also from a decrease in the electric conductivity of the electrolyte membrane.

The power generation characteristics and the change in cell voltage over time, for a constant load current, were measured in the direct methanol fuel cell systems of Examples 6 and 7 in the same way as in Example 5. The systems of Examples 6 and 7 exhibited substantially the same performance as Example 5.

Using an electronic load device, current was made to flow through the direct methanol fuel cell systems of Example 8 and Comparative example 4, to measure fuel cell characteristics. FIG. 10 depicts a graph of the measurement results, in which the abscissa axis represents load current density (mA/cm², value resulting from dividing load current by the effective membrane area of the MEA), and the ordinate axis represents the output density of the cell (mW/cm², product of the load current density by the voltage value (V) between the fuel electrode and the air electrode).

As FIG. 10 shows, in the direct methanol fuel cell system of Example 8 cell voltage was stable during measurement, and maximum output was about 16 mW/cm². Moreover, there was virtually no drop in output after 4 hours of operation in that state, while no rise in the inner pressure of the fuel electrode 2 was observed, either. This result was expectable, on account of absorption of CO₂ gas and concomitant replenishment of water.

In the direct methanol fuel cell system of Comparative example 4, where a methanol solution was supplied, cell voltage was stable during measurement but, by contrast, maximum output was low, of about 14 mW/cm², and current density was likewise poor, presumably on account of crossover. Moreover, output dropped after 4 hours of operation in that state, and the inner pressure in the fuel electrode 2 was also observed to rise.

The power generation characteristics were measured in the direct methanol fuel cell systems of Examples 9 and 10 in the same way as in Example 8. The systems of Examples 9 and 10 exhibited substantially the same performance as that of Example 8. Moreover, there was virtually no drop in output after 4 hours of operation, while no rise in the inner pressure of the fuel electrode 2 was observed, either.

1. A direct methanol fuel cell system, comprising:
a direct methanol fuel cell; and
a fuel container which is provided in the vicinity of a fuel electrode of said fuel cell, and which stores solid-state methanol resulting from making methanol into a solid state.

2. The direct methanol fuel cell system according to claim 1, wherein a film is formed on the surface of said solid-state methanol.

3. The direct methanol fuel cell system according to claim 1, wherein said solid-state methanol is stored together with a water-containing solid material in said fuel container.

4. The direct methanol fuel cell system according to claim 1, further comprising an alkaline inorganic solid that reacts with a gas that is present between the fuel electrode of said direct methanol fuel cell and said fuel container.

5. The direct methanol fuel cell system according to claim 1, wherein said fuel container has no motive power for supplying fuel to said fuel cell.

6. The direct methanol fuel cell system according to claim 2, wherein said solid-state methanol is obtained by turning a methanol aqueous solution into a solid state.

7. The direct methanol fuel cell system according to claim 2, wherein said solid-state methanol having a film formed thereon is stored together with a water-containing solid material in said fuel container.

8. The direct methanol fuel cell system according to claim 2, wherein said film is formed of one, two or more materials selected from among cellulosic materials, polyvinyl alcohol-based materials and polyacrylic acid-based materials.

9. The direct methanol fuel cell system according to claim 4, wherein said alkaline inorganic solid is stored together with said solid-state methanol in said fuel container.

10. The direct methanol fuel cell system according to claim 9, wherein said alkaline inorganic solid is homogeneously mixed with said solid-state methanol.

11. The direct methanol fuel cell system according to claim 4, wherein said alkaline inorganic solid is calcium hydroxide.

12. The direct methanol fuel cell system according to claim 1, wherein said fuel container has an air-permeable surface formed thereon, said air-permeable surface facing the fuel electrode side of said direct methanol fuel cell.

13. The direct methanol fuel cell system according to claim 12, wherein said air-permeable surface is divided by a permeable material through which only gaseous components can pass.

14. The direct methanol fuel cell system according to claim 12, wherein said water-containing solid material is localized at the air-permeable surface side of said fuel container.

15. The direct methanol fuel cell system according to claim 12, wherein said solid-state methanol and said water-containing solid material are stored in said fuel container partitioned from each other so as to face said air-permeable surface.

16. A portable electronic device, comprising the direct methanol fuel cell system according to claim 1.
